(19) United States
(12) Patent Application Publication
(10) Pub. No.: US 2003/0052471 A1
(43) Pub. Date: Mar. 20, 2003

(54) Three-wheeled scooter apparatus

(76) Inventor: Richard Grafton, El Cajon, CA (US)

Correspondence Address: Michael S. Neustel, 2534 South University Drive, Suite No. 4, Fargo, ND, 58103, US

(21) Appl. No.: 09/955,384

(22) Filed: Sep. 17, 2001

(51) Int. Cl. B62K 5/02

(52) U.S. Cl. 280/282; 280/87.041

(57) ABSTRACT

A three-wheeled scooter apparatus for providing a scooter for usage in extreme environments that has a stable and safe structure which can be utilized by various types of individuals in an upright position. The three-wheeled scooter apparatus includes a frame having a center member and a lower structure, a front wheel rotatably attached to the frame, a pair of rear wheels rotatably attached to the lower structure of the frame, a support platform secured to the lower structure forming a flat support surface for the user to stand upon, and a pair of guard members secured to the side portions of the lower structure for protecting the feet of the user. A pair of side arms extend from the lower structure for providing additional support to the rear wheels. A brake member is preferably positioned adjacent to each of the rear wheels for allowing slowing and stopping of the vehicle during travel. The rear wheels are preferably angled upwardly and inwardly for increasing straight line tracking during operation.

### BACKGROUND OF THE INVENTION

1. Field of the Invention

The present invention relates generally to scooter vehicles and more specifically it relates to a three-wheeled scooter apparatus for providing a scooter for usage in extreme environments that has a stable and safe structure.

2. Description of the Prior Art

Three-wheeled vehicles (often times referred to as “tricycles”) have been in use for years. Typically, a tricycle is comprised of a larger front wheel rotatably attached to a front of a frame, a pair of pedals attached to the front wheel for allowing the feet of a user to drive the tricycle, a seat attached to an upper portion of the frame for the user to sit upon, and a pair of wheels attached to a rear portion of the frame. Conventional three-wheeled vehicles are not designed for usage upon irregular terrain and are mainly limited to travel upon flat hard surface such as concrete or asphalt. Another problem with conventional three-wheeled vehicles is that they require the user to sit down and pedal the vehicle to move forwardly which is uncomfortable and awkward for many users.

Scooters are also well known and are generally comprised of a flat frame structure, a rear wheel rotatably attached to the frame, a front wheel rotatably attached to the frame, and elongated handlebars for controlling the front wheel during operation. To move the scooter forward, the user leaves one foot upon the frame and utilizes the other foot to “push” the scooter forwardly. Conventional scooters are inherently unstable and users are susceptible to severe injuries. In addition, conventional scooter are not designed to be operated upon rough and irregular “off road” terrain.

Examples of patented vehicles which are illustrative of such prior art include U.S. Pat. Nos. 5,785,331; 6,089,586; 5,039,121; 5,110,148; and 4,540,192.

While these devices may be suitable for the particular purpose to which they address, they are not as suitable for providing a scooter that has a stable and safe structure. Conventional tricycles and scooters do not provide a safe and feasible vehicle for use in extreme environments.

In these respects, the three-wheeled scooter apparatus according to the present invention substantially departs from the conventional concepts and designs of the prior art, and in so doing provides an apparatus primarily developed for the purpose of providing a scooter that has a stable and safe structure.

### SUMMARY OF THE INVENTION

In view of the foregoing disadvantages inherent in the known types of scooter devices now present in the prior art, the present invention provides a new three-wheeled scooter apparatus construction wherein the same can be utilized for providing a scooter for usage in extreme environments that has a stable and safe structure.

The general purpose of the present invention, which will be described subsequently in greater detail, is to provide a new three-wheeled scooter apparatus that has many of the advantages of the scooter devices mentioned heretofore and many novel features that result in a new three-wheeled scooter apparatus which is not anticipated, rendered obvious, suggested, or even implied by any of the prior art scooter devices, either alone or in any combination thereof.

To attain this, the present invention generally comprises a frame having a center member and a lower structure, a front wheel rotatably attached to the frame, a pair of rear wheels rotatably attached to the lower structure of the frame, a support platform secured to the lower structure forming a flat support surface for the user to stand upon, and a pair of guard members secured to the side portions of the lower structure for protecting the feet of the user. A pair of side arms extend from the lower structure for providing additional support to the rear wheels. A brake member is preferably positioned adjacent to each of the rear wheels for allowing slowing and stopping of the vehicle during travel.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a three-wheeled scooter apparatus that will overcome the shortcomings of the prior art devices.

A second object is to provide a three-wheeled scooter apparatus for providing a scooter for usage in extreme environments that has a stable and safe structure.

Another object is to provide a three-wheeled scooter apparatus that may be utilized upon various types of surfaces such as concrete, asphalt, dirt, gravel, grass and other non-flat surfaces.

An additional object is to provide a three-wheeled scooter apparatus that may be utilized upon irregular and rugged terrain.

A further object is to provide a three-wheeled scooter apparatus that may be utilized similar to mountain bicycles and the like.

A further object is to provide a three-wheeled scooter apparatus that is more stable and easier to utilize than conventional three-wheeled and scooter vehicles.

Another object is to provide a three-wheeled scooter apparatus that utilizes angled rear wheels for increasing straight line tracking while operating.

A further object is to provide a three-wheeled scooter apparatus that provides a safe and easy to utilize braking system that allows the user to increase the steering abilities of the vehicle.

Another object is to provide a three-wheeled scooter apparatus that may be utilized by individuals of various ages from children to adults.

A further object is to provide a three-wheeled scooter apparatus that utilizes a flat and broad support platform extending between the rear wheels for the user to stand upon and increase the user's feeling of the operation of the vehicle.

Another object is to provide a three-wheeled scooter apparatus that does not utilize a “pedal drive” to operate.

A further object is to provide a three-wheeled scooter apparatus that may be operated at a relatively high velocity.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a top view of the present invention.

FIG. 3 is a side view of the present invention.

FIG. 4 is a rear view of the present invention.

### DESCRIPTION OF THE PREFERRED EMBODIMENT

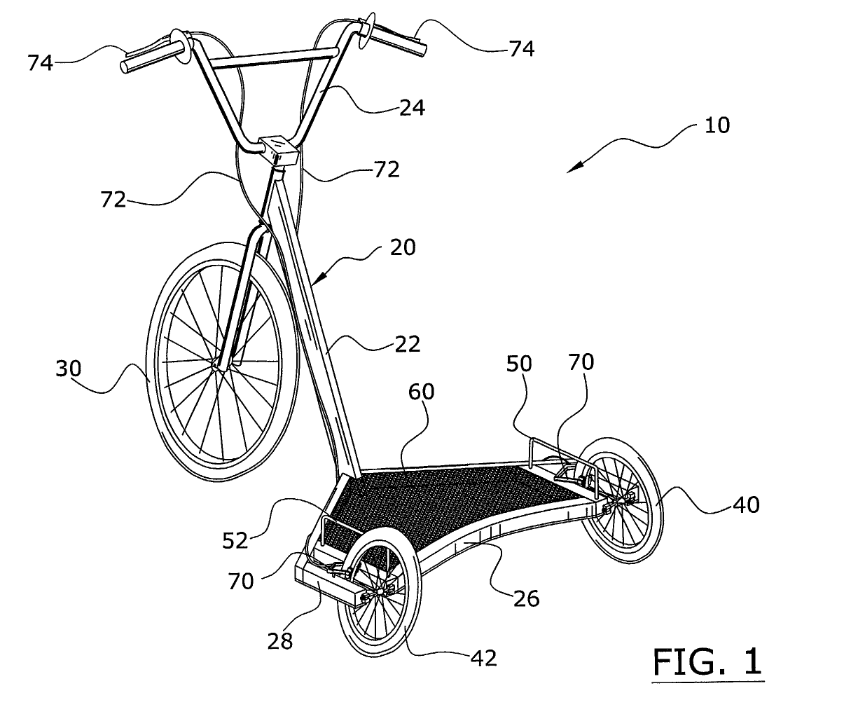

Turning now descriptively to the drawings, in which similar reference characters denote similar elements throughout the several views, FIGS. 1 through 4 illustrate a three-wheeled scooter apparatus 10, which comprises a frame 20 having a center member 22 and a lower structure 26, a front wheel 30 rotatably attached to the frame 20, a pair of rear wheels 40, 42 rotatably attached to the lower structure 26 of the frame 20, a support platform 60 secured to the lower structure 26 forming a flat support surface for the user to stand upon, and a pair of guard members 50, 52 secured to the side portions of the lower structure 26 for protecting the feet of the user. A pair of side arms 28 extend from the lower structure 26 for providing additional support to the rear wheels 40, 42. A brake member 70 is preferably positioned adjacent to each of the rear wheels for allowing slowing and stopping of the vehicle during travel.

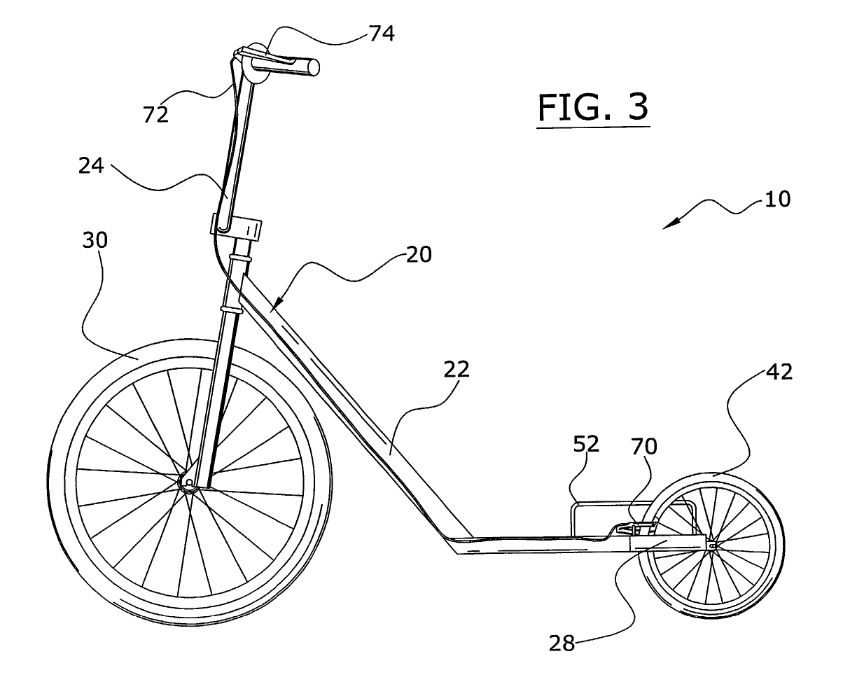

As shown in FIGS. 1 through 3 of the drawings, the frame 20 is comprised of an elongate structure. The frame 20 is mainly comprised of a center member 22 and a lower structure 26. As best shown in FIG. 3 of the drawings, the center member 22 extends upwardly and forwardly at an angle from the lower structure 26 a finite distance directly above the front wheel 30. The center member 22 may have a straight, curved or irregular shape as can be appreciated.

As shown in FIGS. 1 and 3 of the drawings, a set of handlebars 24 are rotatably supported within a front portion of the center member 22 of the frame 20. The handlebars 24 may be comprised of various sizes, shapes and designs. The handlebars 24 are preferably elevated to a height sufficient for the user to stand upon the support platform 60 and adequately control the vehicle during operation.

The front wheel 30 is rotatably supported within a U-shaped structure attached to the handlebars 24 as shown in FIG. 1 of the drawings. The front wheel 30 is preferably larger in diameter then the rear wheels 40, 42. The front wheel 30 preferably is comprised of a pneumatic structure, however various other well known wheel structures may be utilized as can be appreciated.

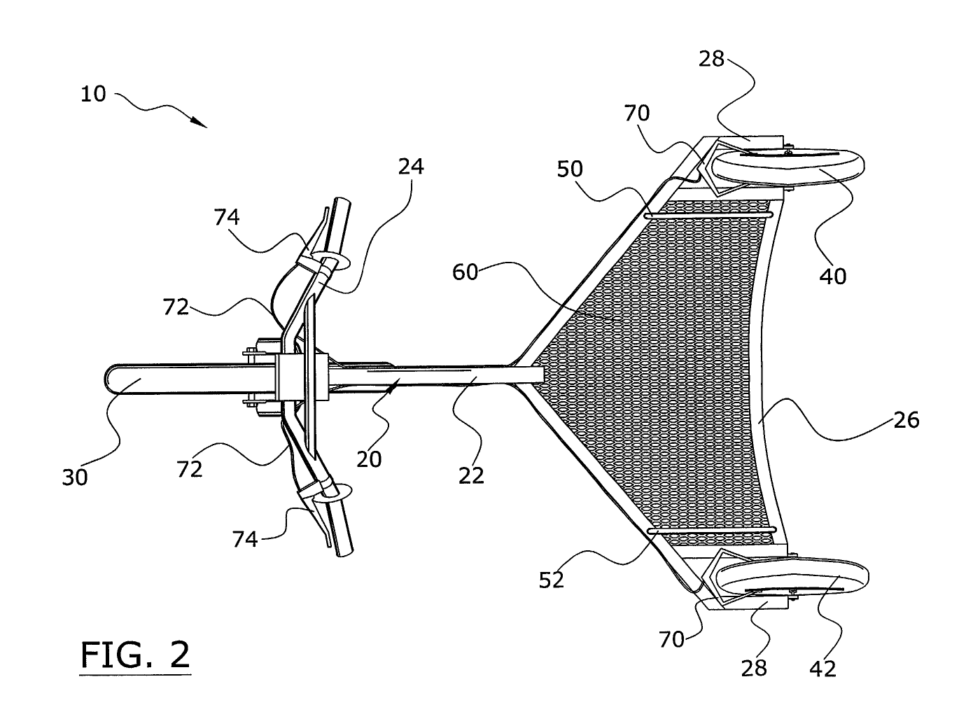

The lower structure 26 is comprised of a flat structure as best shown in FIGS. 1, 3 and 4 of the drawings. The lower structure 26 has a pair of front angled members that are attached to the end of the center member 22 opposite of the handlebars 24 as best shown in FIG. 2 of the drawings. As further shown in FIG. 2 of the drawings, the lower structure 26 further includes a pair of side members that extend rearwardly from each of the front angled members along with a rear member extending between the pair of side members. The rear member is preferably comprised of a concave structure as further shown in FIG. 2 of the drawings. The concave structure of the rear member allows for the user to stand upon one side of the support platform 60 while the other foot pushes centrally without engaging the support platform 60 or the lower structure 26.

As shown in FIGS. 1 and 2 of the drawings, the support platform 60 is secured about the lower structure 26 providing a flat and solid structure for the user to stand upon. The support platform 60 is preferably comprised of a structure having a plurality of openings within, however a solid structure may also be utilized. The support platform 60 may also be constructed of various types of materials such as but not limited to metal and plastic. Gripping members and other accessories may be added to the support platform 60 to increase the safety of the operation of the vehicle.

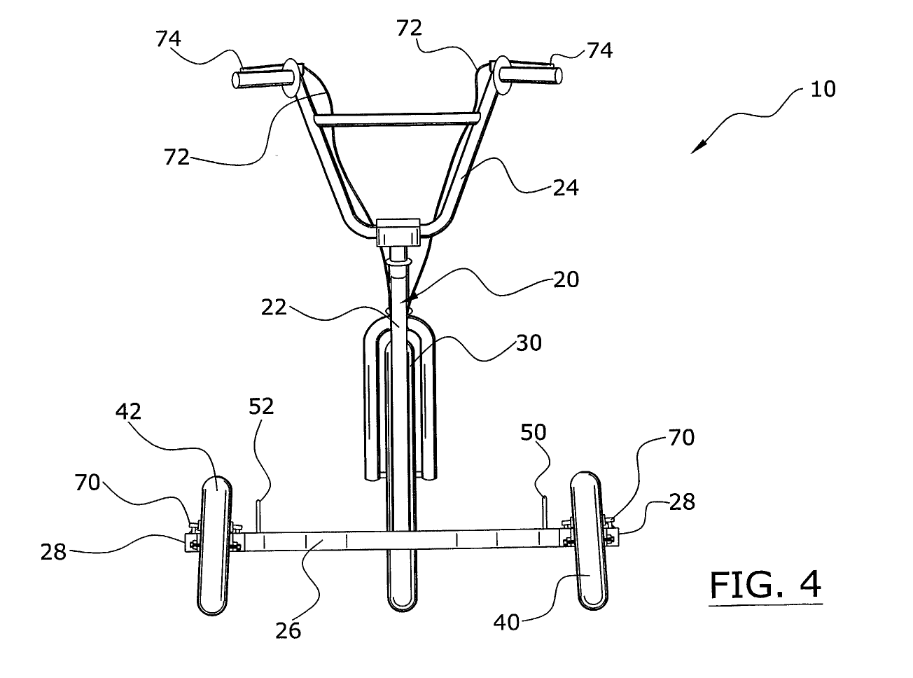

As shown in FIGS. 1 through 4 of the drawings, a pair of side arms 28 extend outwardly from the lower structure 26 substantially parallel to the side members of the lower structure 26. As best shown in FIGS. 2 and 4 of the drawings, the first rear wheel 40 and the second rear wheel 42 are rotatably attached between the side arms 28 and the lower structure 26. The rear wheels 40, 42 are preferably angled upwardly and inwardly for increasing the stability and tracking of the vehicle as best illustrated in FIG. 4 of the drawings.

As shown in FIGS. 1, 2 and 4 of the drawings, a first guard member 50 and a second guard member 52 are attached to opposing sides of the lower structure 26 adjacent each of the respective rear wheels 40, 42. The guard members 40, 42 prevent the user's feet from sliding from the support platform 60 and engaging the rear wheels 40, 42. The guard members 40, 42 are preferably comprised of an inverted U-shaped structure as best illustrated in FIG. 1 of the drawings.

A brake member 70 is preferably attached to the lower structure 26 of the frame 20 and engagable with each of the rear wheels 40, 42. A brake handle 74 attached to each of the handlebars 24 is mechanically connected to and controlling each brake member 70 via a length of cable 72 or similar means. The user is able to brake each of the rear wheels 40, 42 independently from the other for increasing the user's ability to turn and control the vehicle during operation.

In use, the user contracts at least one brake handle 74 to prevent movement of the vehicle. The user then places one foot upon the support platform 60 and grasps the handlebars 24 with their hands. The user then pushes forwardly with the other foot thereby causing forward movement of the vehicle. The user leans in the appropriate direction when encountering turns and rough terrain to maintain the stability of the vehicle during operation. In addition, the user may utilize the brake handles 74 to assist in steering and guiding the vehicle during operation thereof.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A three-wheeled scooter apparatus, comprising:
a frame having a center member and a lower structure attached to said center member, wherein said lower structure has a flat structure;
a set of handlebars rotatably attached to said center member opposite of said lower structure;
a front wheel rotatably attached to said set of handlebars;
a support platform attached to said lower structure; and
a pair of rear wheels rotatably attached to said lower structure.

2. The three-wheeled scooter apparatus of claim 1, wherein said support platform completely encloses said lower structure.

3. The three-wheeled scooter apparatus of claim 1, wherein said lower structure is comprised of:
a pair of front members that extend outwardly at an angle from said center member;
a pair of side members extending rearwardly from said front members parallel to one another; and
a rear member extending between said pair of side members.

4. The three-wheeled scooter apparatus of claim 3, wherein said rear member is curved inwardly.

5. The three-wheeled scooter apparatus of claim 1, wherein said front wheel has a diameter equal to or greater than the diameter of said pair of rear wheels.

6. The three-wheeled scooter apparatus of claim 1, wherein said handlebars extend upwardly a finite distance.

7. The three-wheeled scooter apparatus of claim 1, wherein said support platform includes a plurality of openings.

8. The three-wheeled scooter apparatus of claim 7, wherein said support platform completely encloses said lower structure.

9. The three-wheeled scooter apparatus of claim 1, including a first braking structure and a second braking structure in selective engagement with said pair of rear wheels respectively.

10. The three-wheeled scooter apparatus of claim 9, wherein said first braking structure and said second braking structure each include a braking member, a cable mechanically connected to said braking member, and a brake handle attached to said cable opposite of said brake member for controlling said brake member.

11. The three-wheeled scooter apparatus of claim 1, including a first guard member and a second guard member attached to opposing sides of said lower structure for preventing a foot of a user from engaging said pair of rear wheels.

12. The three-wheeled scooter apparatus of claim 11, wherein said first guard member and said second guard member are each comprised of an inverted U-shaped structure.

13. The three-wheeled scooter apparatus of claim 11, wherein said lower structure is comprised of:
a pair of front members that extend outwardly at an angle from said center member;
a pair of side members extending rearwardly from said front members parallel to one another; and
a rear member extending between said pair of side members.

14. The three-wheeled scooter apparatus of claim 13, wherein said rear member is curved inwardly.

15. The three-wheeled scooter apparatus of claim 11, wherein said front wheel has a diameter equal to or greater than a diameter of said pair of rear wheels.

16. The three-wheeled scooter apparatus of claim 11, wherein said handlebars extend upwardly a finite distance.

17. The three-wheeled scooter apparatus of claim 11, wherein said support platform includes a plurality of openings.

18. The three-wheeled scooter apparatus of claim 17, wherein said support platform completely encloses said lower structure.

19. The three-wheeled scooter apparatus of claim 11, including a first braking structure and a second braking structure in selective engagement with said pair of rear wheels respectively.

20. The three-wheeled scooter apparatus of claim 19, wherein said first braking structure and said second braking structure each include a braking member, a cable mechanically connected to said braking member, and a brake handle attached to said cable opposite of said brake member for controlling said brake member.
